(19) United States
(12) Patent Application Publication
(10) Pub. No.: US 2019/0164228 A1
(43) Pub. Date: May 30, 2019

(54) PROXY TO PRICE GROUP BENEFITS

(71) Applicant: HARTFORD FIRE INSURANCE COMPANY, Hartford, CT (US)

(72) Inventors: Michael Edward EWALD, Hartford, CT (US); Stephen J. ALOI, Glastonbury, CT (US); Alexander David MAREK, Wallingford, CT (US); Brian D. MANGENE, Southington, CT (US); Donato L. MONACO, Cromwell, CT (US); Stacey W. PAPA, Tolland, CT (US); Qiao WANG, Avon, CT (US); Paul Renaud LAVALLEE, Falmouth, ME (US); Mark Alan COSLETT, West Simsbury, CT (US)

(73) Assignee: HARTFORD FIRE INSURANCE COMPANY, Hartford, CT (US)

(21) Appl. No.: 15/826,506

(22) Filed: Nov. 29, 2017

(51) Int. Cl. G06Q 40/08; G06Q 10/10

(52) U.S. Cl. CPC G06Q 40/08; G06Q 10/1057

(57) ABSTRACT

A system and method for providing and utilizing a proxy to provide group benefits products is disclosed. The system and method include providing at least one variable for calculating applicability and cost of a group benefits product by proxy, wherein the proxy is provided by information included in at least a workers compensation (WC) system. The at least one variable may include WC average salary, area, industry, blue score and/or median household age. The group benefit product may be a long term disability insurance product and/or a life insurance product.

### FIELD OF INVENTION

The present invention is directed to reducing the need for information in pricing group benefits, and more particularly, to using proxies in pricing group benefits.

### BACKGROUND

In providing group benefits, provider companies prefer to identify information regarding numerous variables before providing pricing information for such benefits. Such variables may include age, salary and gender, for example. These variables are required to properly assess the liability and risk associated with the benefits. As the cost for the benefits is related to the risk associated with benefits, assessment of the variables to properly quantify risk factors is essential to providing proper benefit products. Often these variables are unknown or may require additional interaction with potential insureds in order to form a quote for the benefits. Therefore, a need exists to provide quotes and pricing information absent the need for information regarding the numerous variables.

### SUMMARY

A system and method for providing and utilizing a proxy to provide group benefits products is disclosed. The system and method include providing at least one variable for calculating applicability and cost of a group benefits product by proxy, wherein the proxy is provided by information included in at least a workers compensation (WC) system. The at least one variable may include WC average salary, area, industry, blue score and/or median household age. The group benefit product may be a long term disability insurance product and/or a life insurance product.

The system and method operating to repurpose the WC system information to proxy for a group benefit (GB) product offer. The system and method providing feedback to cause self-tuning of the proxy system. The system and method further using third party data to fill in gaps and/or proxy information to provide the GB product offer.

### BRIEF DESCRIPTION OF THE DRAWINGS

A more detailed understanding may be had from the following description, given by way of example in conjunction with the accompanying drawings wherein:

FIG. 1 illustrates a system for providing and utilizing a proxy to provide group benefits;

FIG. 2 illustrates an information flow within the system of FIG. 1;

FIG. 3 illustrates a table of variables, the source of the proxy for each variable, and an explanation of how each proxy represents the variables used in a group benefits (GB) system;

FIG. 4 illustrates a method for creating the proxy for use as variables in the pricing, product design and monitoring of the system of FIGS. 1 and 2;

FIG. 5 illustrates a method for providing and utilizing a proxy to provide group benefits;

FIG. 6 illustrates a plot of the life and term disability (LTD) results using the proxy information;

FIG. 7 illustrates a plot of the life results using the proxy information;

FIG. 8 illustrates a plot of the actual and expected LTD claims by experience mod;

FIG. 9 illustrates a plot of the actual and expected LTD claims by National Council on Compensation Insurance (NCCI) rate;

FIG. 10 illustrates a plot of the actual and expected life claims by experience mod;

FIG. 11 illustrates a dashboard that may be provided within the transition layer of FIGS. 1 and 2;

FIGS. 12-15 provide illustrations of presentable quotes from the quoting and submission system of FIGS. 1 and 2; and

FIGS. 16-18 provide illustrations on the feedback within the system of FIGS. 1 and 2.

### DETAILED DESCRIPTION

In the following description, numerous specific details are set forth, such as particular structures, components, materials, dimensions, processing steps, and techniques, in order to provide a thorough understanding of the present embodiments. However, it will be appreciated by one of ordinary skill of the art that the embodiments may be practiced without these specific details. In other instances, well-known structures or processing steps have not been described in detail in order to avoid obscuring the embodiments. It will be understood that when an element such as a layer, region, or substrate is referred to as being “on” or “over” another element, it can be directly on the other element or intervening elements may also be present. In contrast, when an element is referred to as being “directly on” or “directly” over another element, there are no intervening elements present. It will also be understood that when an element is referred to as being “beneath,” “below,” or “under” another element, it can be directly beneath or under the other element, or intervening elements may be present. In contrast, when an element is referred to as being “directly beneath” or “directly under” another element, there are no intervening elements present.

In the interest of not obscuring the presentation of embodiments in the following detailed description, some structures, components, materials, dimensions, processing steps, and techniques that are known in the art may have been combined together for presentation and for illustration purposes and in some instances may have not been described in detail. In other instances, some structures, components, materials, dimensions, processing steps and techniques that are known in the art may not be described at all. It should be understood that the following description is rather focused on the distinctive features or elements of various embodiments described herein.

The present system and method are directed to providing a product offering with appropriate pricing and using monitoring and feedback to ensure that the product and associated offering are complementary. The product offering with the appropriate pricing of the product may be determined using proxy for information normally used to provide the product and pricing. For example, workers' compensation information may be leveraged to offer binding long term disability and life insurance quotes even if the information needed to make such quotes remain unknown.

The products offered in the present system and method may be low benefit levels with simplified plan design. These products may be attractive to new buyers and may reduce the anti-selection risk where nearly two-thirds of small businesses do not have long term disability and/or life insurance.

The pricing associated with the products may utilize proxy information in place of unknown information. For example, the underlying census of the employer may be approximated by using the census model as an input. Other variables may be used to enhance risk selection, possibly exceeding that currently achieved.

The monitoring associated with the system and method may occur by monitoring manually priced cases and comparing those to the census modeled cases. Further, the policies may be time limited to allow deviation from the current strategy based on the monitoring.

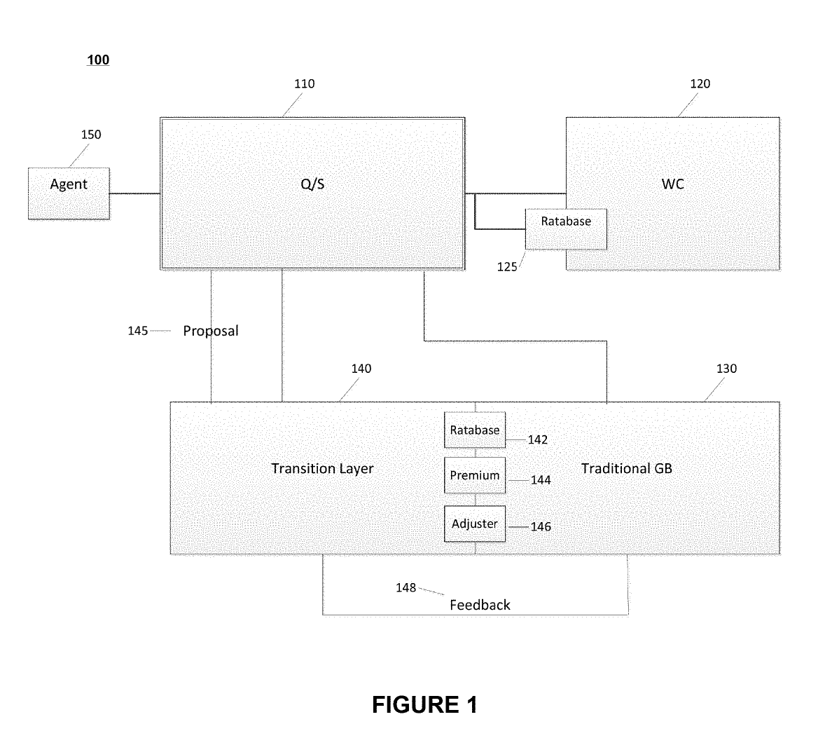

FIG. 1 illustrates a system 100 for providing and utilizing a proxy to provide group benefits as described herein. System 100 includes a quoting and submission system (QS) 110, a workers compensation system (WC) 120, a traditional group benefits system (GB) 130, and a transition layer 140. System 100 operates to provide quotes and other information to an agent or series of agents 150. An agent 150 may use QS 110 to provide a workers compensation quote using workers compensation system 120. The WC quote may be computed using ratabase 125. Commensurate with the WC quote, transition layer 140 utilizes information provided for the WC quote to proxy the information to provide a GB quote. This proxied information is processed through ratabase 142, premium 144, and adjuster 146 and the proposal 145 for GB is provided to QS 110. In the event that the proposal for GB benefit coverage is closed, the underlying information provided with the policy is used to run a GB quote. This information is provided to traditional GB system 130 and ratabase 142, premium 144, and adjuster 146 are used on the information to generate a traditionally calculated GB quote. This traditional calculation may occur after the product is purchased and full insured information is received. This quote is compared with the quote from the transition layer 140 across feedback 148. In this system the WC information is repurposed and modified into the generation of a new product—the GB quote. The feedback loop provides self-tuning of the process and as will be described in detail below, and missing information may be filled in using third party data.

QS 110 may provide an electronic quoting and submission system with web-based access, efficient navigation, and a host of integrated features that streamline the submission process for the company's key small business coverages including business owners' policy, workers' compensation and commercial auto. QS 110 may include at least one processor, one memory or storage device, and at least one communication interface to provide information to the other elements within FIG. 1.

WC 120 may be coupled via communication interfaces with QS system 110 to enable communication and sharing of information as necessary to perform the quoting and feedback discussed herein. WC 120 may be a system designed to receive information and use that received information to process a quote for WC, and ultimately, when the quote is accepted, to bind an insurance policy for WC. Generally in quoting WC, lost time of the worker is the big risk that needs to be accounted for. This parallels LTD as lost time is also included in the risk. WC 120 may include at least one processor, one memory or storage device, and at least one communication interface to provide information to of elements within FIG. 1.

Traditional group benefits (GB) system 130 represents the system that generally provides group benefits quotes and products. GB system 130 may be coupled via communication interfaces with QS 110 to enable communication and sharing of information as necessary to perform the quoting and feedback discussed herein. GB system 130 generally utilizes age, salary and gender to price and offer products. GB system 130 may include numerous databases (not shown) to store data, at least one communication interface to receive and send information with other entities in the system 100. Generally, traditional GB may be quoted by analyzing specifics of individuals. Based on specific individual information GB quotes may be calculated. Traditional GB system 130 may include at least one processor, one memory or storage device, and at least one communication interface to provide information to of elements within FIG. 1.

Transition layer 140 may be located communicatively coupled to QS 110 and coupled to ratabase 142, premium 144, and adjustor 146 found in traditional GB system 130. FIG. 1 illustrates transition layer 140 share ratabase 142, premium 144, and adjuster 146 from traditional GB system 130, although separate systems may be used. Transition layer 140 may be coupled via communication interfaces with QS 110 to enable communication and sharing of information as necessary to perform the quoting and feedback discussed herein. Transition layer 140 may provide a proposal 145 as will be discussed. Proposal 145 may be communicated to both QS 110 and to traditional GB system 130. The connection of the proposal 145 with the traditional GB system 130 enables feedback 148 as will be described in more detail herein.

Transition layer 140 may utilize ratabase 142, premium 144, and adjuster 146 to provide a proposal 145 or quotation for GB benefits. Ratabase 142 is an engine to price LTD, life insurance and individual data. Transition layer 140 may provide the proposal to QS 110 to be included with a quote, or coupled to other quotes being provided to agent 150 or other entities.

Transition layer 140 represents a layer that utilizes the proxy information to replace variables utilized by GB system 130.

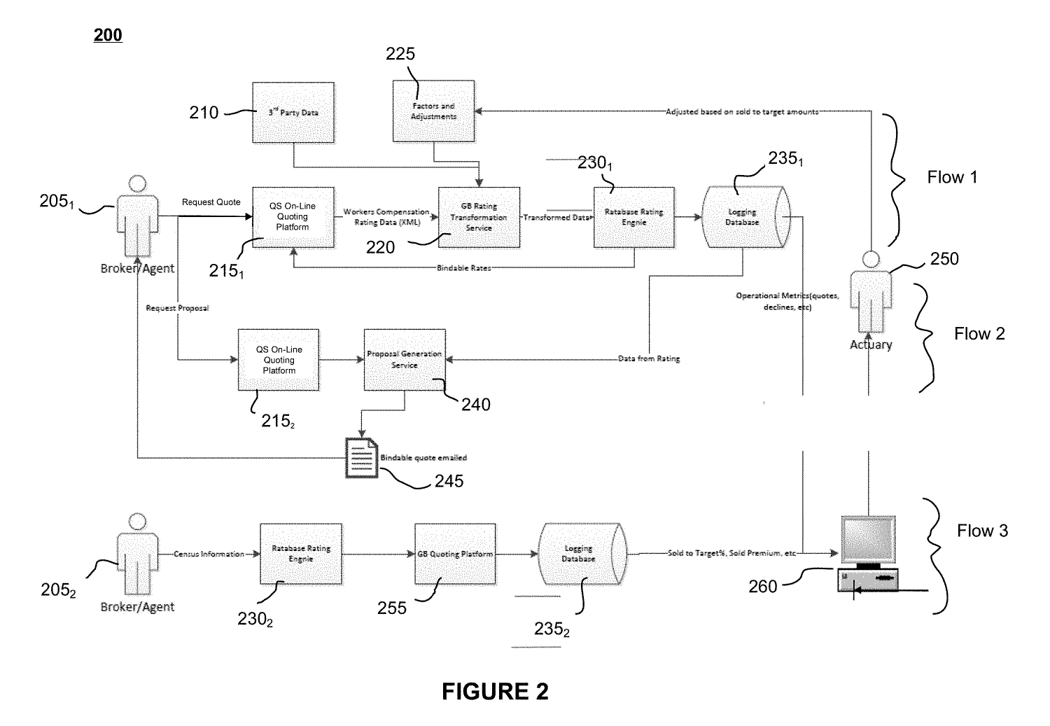

FIG. 2 illustrates an information flow 200 within the system of FIG. 1. Flow 200 may be divided into three parts depicted as Flow 1, Flow 2, and Flow 3. In Flow 1, the proxy for GB product occurs and a quote is produced. In Flow 2, the produced quote from Flow 1 is provided back to the agent/broker so that it may be sold. In Flow 3, the quote from Flow 1 is verified after the sale in Flow 2 and the real underlying data is received allowing a traditional GB pricing to occur, the quote from Flow 1 may be compared with the traditional quote system quote based on the real data to provide feedback to system 100.

In Flow 1, a broker or agent 205₁ requests a WC quote from the QS quoting platform 215₁. In requesting the WC quote, the data is transformed from the WC quote to a GB rating at GB rating transformation service 220. The transformed data is then input into the ratabase rating engine 2301 to produce a bindable rate quote for GB product. The bindable rate quote for GB is provided back to QS quoting platform 215₁ to alert the agent 205₁. The logging database 235₁ records and/or tracks the rate quote.

GB rating transformation service 220 may receive inputs including 3rd party data 210 and factors and adjustments 225. Third party data 210 may include blue scores, zip code information, census data and other types of third party data described herein.

Once the quote is created in Flow 1, the agent 205₁ may determine that the quote is appealing and may decide to present the quote to the potential insured. In Flow 2, the quote that was provided back to the agent 205₁ is emailed or otherwise transmitted to a consumer (not shown). Again, agent 205₁ interacts with the QS quoting platform 215₂ and the proposal generation service 240 receives the quote from the logging database 235₁ and emails the quote to the consumer at step 245.

After the sale resulting from the delivered quote 245, the actual underlying information needed to provide a GB quote in the traditional quoting may be received. This information is used in Flow 3 to verify the transformed quoting performed in Flow 1. While the quote from Flow 1 is what is being charged the accuracy of that quote may be verified to enable improved proxy data for subsequent quotes. The broker/agent 205₂ provides the information to the ratabase rating engine 230₂, which then feeds the GB quoting platform 255 to produce a traditional GB quote. This traditional GB quote is logged into logging database 235₂ and may be compared with the transformed quote logged in logging database 235₁. Dashboards 260 of various information may be provided based on this comparison and an actuary 250 may monitor the dashboards 260 to determine how the proxy quoting is performing. This feedback may also occur without human intervention and as a feedback, factors and adjustments 225 (input to GB Rating transformation service 220) may be modified. This information may provide feedback to factors and adjustments 225 in the proxy quoting system.

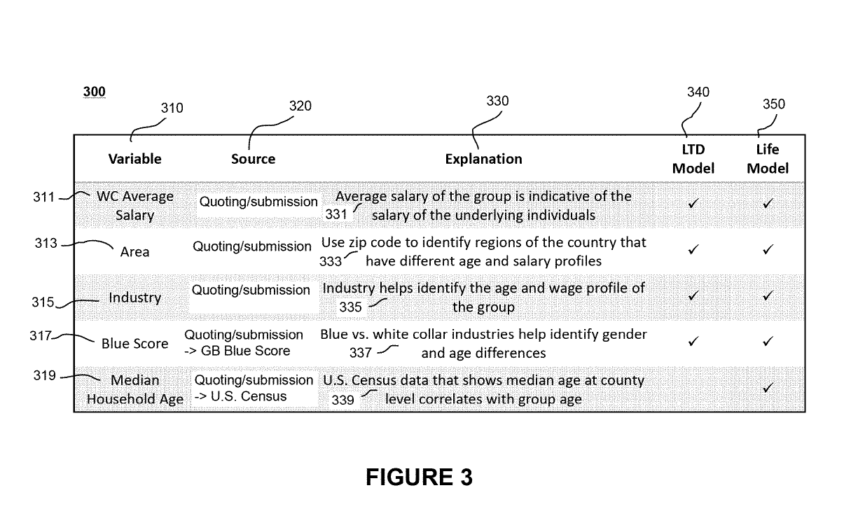

Referring now also to FIG. 3, there is shown a table 300 of variables 310, the source 320 of the proxy for each variable, and an explanation 330 of how each proxy represents the variable used in GB system 130. Additionally, table 300 indicates the applicability of the proxy to each of life and term disability (LTD) model 340 and life model 350.

More specifically, variables 310 include WC average salary 311, area 313, industry 315, blue score 317 and median household age 319. WC average salary 311 is provided by a source of QS 110 of FIG. 1, and is applicable to LTD model 340 and life model 350. Explanation 330 includes an average salary of the group is indicative of the salary of the underlying individuals at 331.

Area 313 is provided by a source of QS 110 of FIG. 1, and is applicable to LTD model 340 and life model 350. Explanation 330 includes using zip code to identify regions of the country that have different age and salary profiles at 333.

Industry 315 is provided by a source of QS 110 of FIG. 1, and is applicable to LTD model 340 and life model 350. Explanation 330 includes using industry to help identify the age and wage profile of the group at 335.

Blue score 317 is provided by a source of QS 110 and GB system 130 of FIG. 1, and is applicable to LTD model 340 and life model 350. Explanation 330 includes using blue vs. white collar industries to aid in identifying gender and age differences at 337.

Median household age 319 is provided by a source of QS 110 of FIG. 1 and United States Census data, and is applicable to life model 350. Explanation 330 includes using Census data that shows median age at county level that correlates with age group at 339.

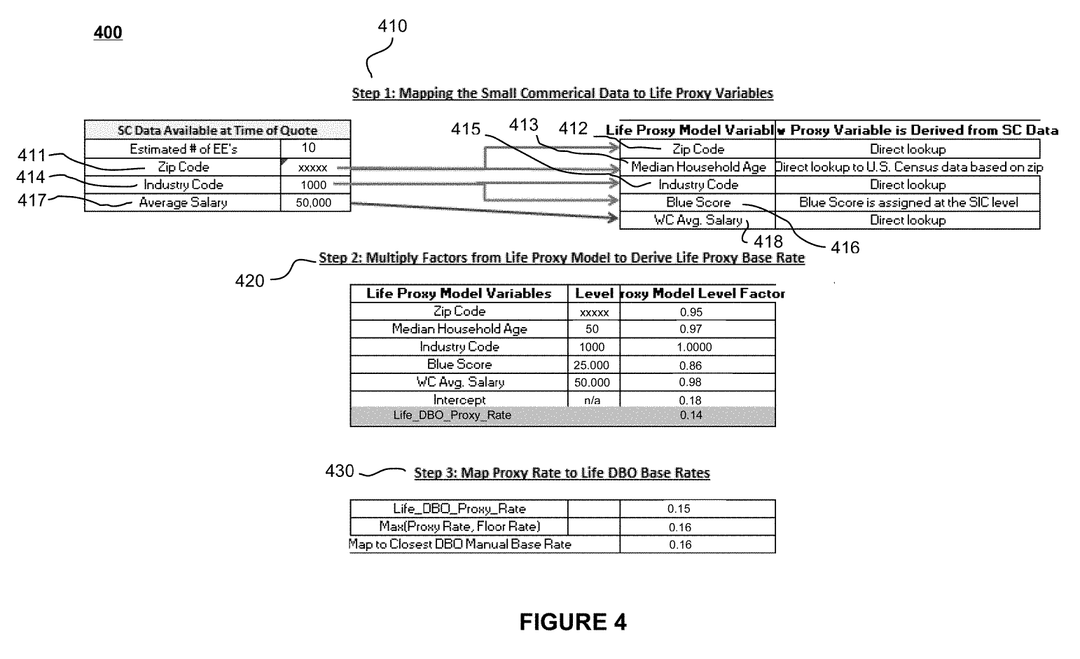

A method 400 is illustrated in FIG. 4 for creating the proxy of variables for use as variables in the pricing, product design and monitoring of system 100. In the specific example proxy of FIG. 4, method 400 involves three main steps. First is the mapping of the small commercial data to life proxy variable at step 410. At step 420, the factors from the life proxy model are multiplied to derive life proxy base rates. At step 430, the proxy rates are mapped to life death benefit option (DBO) base rates.

The mapping of the small commercial data to life proxy variable at step 410 includes utilizing zip code 411 from the small commercial data that is available at the time of the quote to proxy the life proxy model variable zip code 412 and median household age 413. This proxy uses more general demographic or higher level information to proxy individual information. The mapping may also include using the industry code 414 to proxy industry code 415 and blue score 416. The mapping may also include using the average salary 417 for the WC average salary 418.

At step 420, the factors from the life proxy model are multiplied to derive life proxy base rates. Each of the proxy variables in the mapping 410 are assigned multiplying factors at step 420. These multiplying factors may be determined and assigned using statistical modeling of correlations between the WC data being used for the GB proxy.

At step 430, the proxy rates are mapped to life DBO base rates. In combination with step 420, step 430 converts the life DBO proxy into a ratabase input in order to provide quote. This mapping allows each of the proxied variables to “proxy” for the variable being substituted and functionally operate in the system, i.e., ratabase.

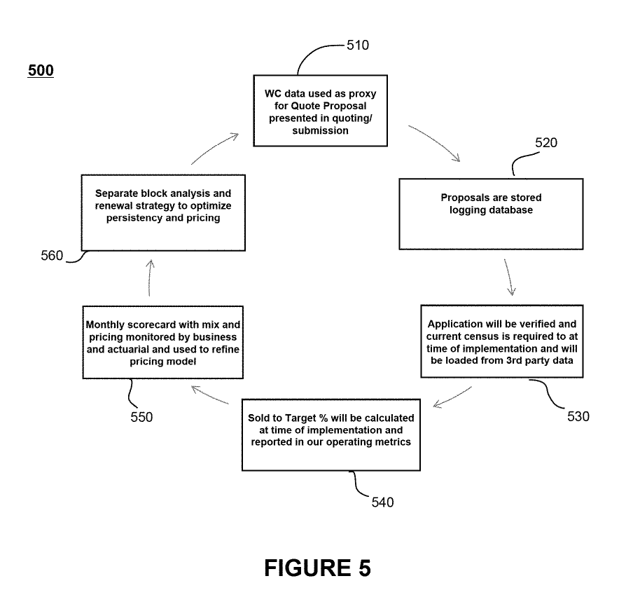

FIG. 5 illustrates a method 500 for providing and utilizing a proxy to provide group benefits as described herein. FIG. 5 operates in conjunction with FIGS. 1 and 2 including QS 110, 215, logging database 235, and 3rd party data 210, for example. At step 510, method 500 includes using WC data as a proxy for a quote proposal presented in QS 110 of FIG. 1. At step 520, proposals may be downloaded by agents 150 of FIG. 1 are stored in logging database 235 of FIG. 2. At step 530, the application is verified and the current census is implemented and loaded from 3rd party data 210 of FIG. 2. At step 540, the Target % is calculated at the time of implementation and reported based on feedback 148 of FIG. 1. A monthly scorecard with mix and pricing may be used to monitor business and actuarial model to refine pricing model as feedback 148 of FIG. 1, at step 550. At step 560, method 500 includes a block analysis and renewal strategy to optimize persistency and pricing. For example, the monitoring associated with the system and method may occur by monitoring manually priced cases and comparing those to the census modeled cases. Further, the policies may be time limited to allow deviation from the current strategy based on the monitoring.

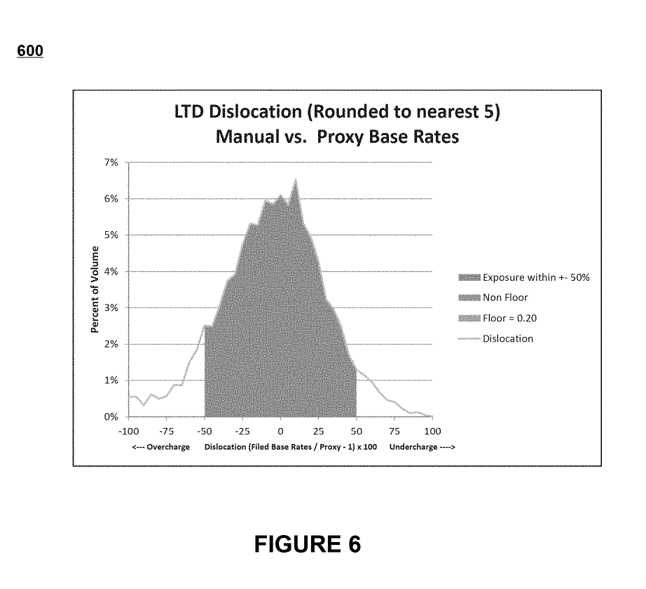

FIG. 6 illustrates a plot 600 of the LTD results using the proxy information. FIG. 6 illustrates a plot of the percent volume plotted against the dislocation. Dislocation is the number of filings at base rates over the number of proxy rates multiplied by 100. As shown, overcharge conditions are plotted to the left in the negative dislocation, while positive dislocation represents undercharge conditions. LTD dislocation is centered on zero evidencing an average charge that is correct and dislocation is normally distributed evidencing equal over- and under-charge conditions as shown in FIG. 6. FIG. 6 illustrates that the proxy information maintains approximately 90 percent of exposure within ±50% of the level of deviation, i.e., compared to the use of the traditional quote system. This small deviation may be accounted for in a number of other ways, such as by flooring rates at 0.25 in order to reduce the risk of undercharging. This flooring may build margin into the program.

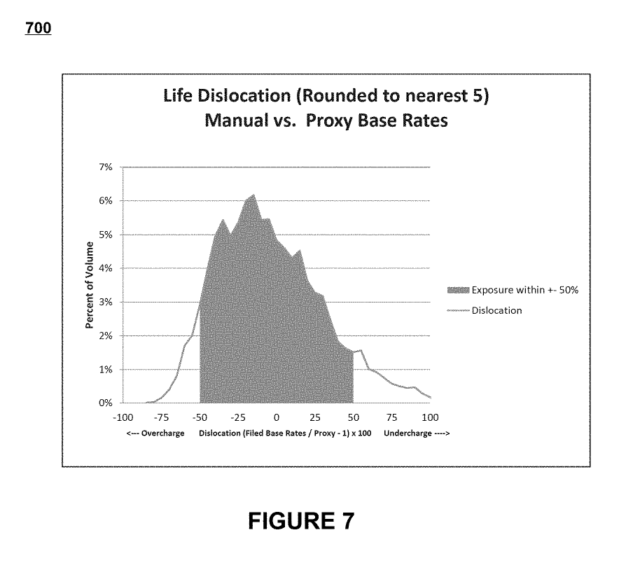

FIG. 7 illustrates a plot 700 of the life results using the proxy information. FIG. 7 illustrates a plot of the percent volume plotted against the dislocation. As shown, overcharge conditions are plotted to the left in the negative dislocation, while positive dislocation represents undercharge conditions. Life dislocation is centered on zero evidencing an average charge that is correct and dislocation is distributed with a slight skew evidencing that a larger proportion of cases are slightly overcharged as shown in FIG. 7. FIG. 7 illustrates that the proxy information maintains approximately 85 percent of exposure within ±50% of the level of deviation, i.e., compared to the use of the traditional quote system. This small deviation may be accounted for in a number of other ways, such as by flooring rates at 0.167 in order to reduce the risk of undercharging. This flooring may build margin into the program.

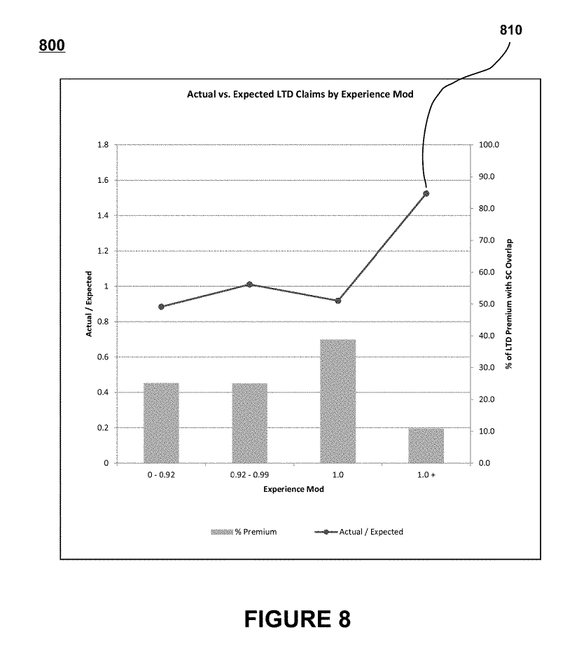

FIG. 8 illustrates a plot 800 of the actual and expected LTD claims by experience mod. Experience mod is the experience of the insured with respect to losses over three years, from the WC insurance, where 1 is equal to peers, greater than 1 is worse than peers, and less than 1 is better than peers. Also illustrated in the plot is percent of LTD premium with SC overlap. Experience mod may be used in WC rating where rate is greater than 1 indicates bad WC claims experience and less than 1 indicates good WC experience. In cases 810 where experience mod is greater than 1 there is a 50% detriment below standard. Pricing may be controlled by not providing a quote to WC cases with experience mod above 1.0, which corresponds to roughly 10% of quotes. These situations may be handled by requesting information and using the traditional system, in part, because of the nature of these situations.

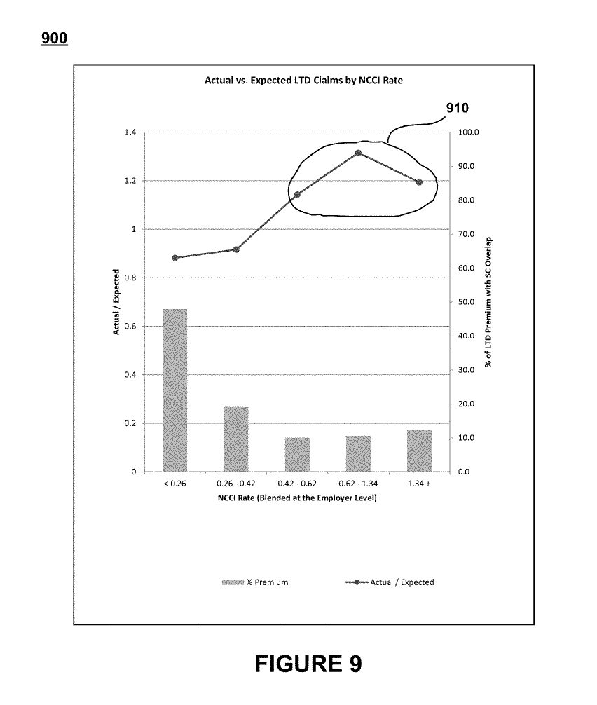

FIG. 9 illustrates a plot 900 of the actual and expected LTD claims by National Council on Compensation Insurance (NCCI) rate. NCCI rate includes rates, loss costs, and rating values. Also illustrated in the plot is percent of LTD premium with SC overlap. NCCI rate may be used in WC rating where a lower rate corresponds to low competitive risk and higher rate corresponds to a higher competitive risk. In cases collectively 910 where NCCI rate run 20-30% above manual. Pricing may be controlled by increasing rate for cases with higher NCCI rate, such as up to 30% more rate in the highest risk categories.

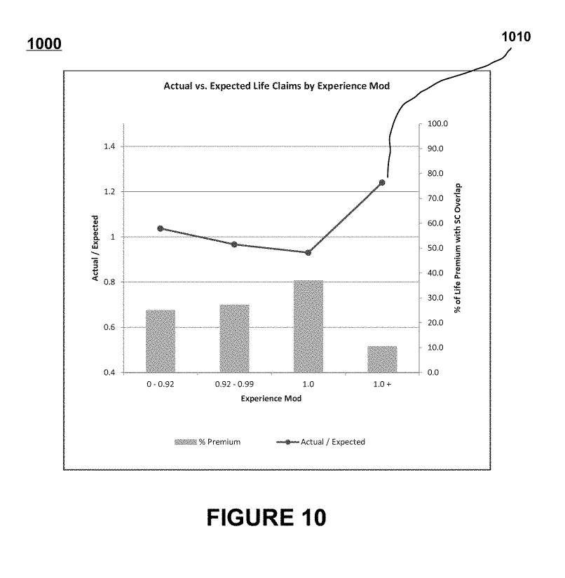

FIG. 10 illustrates a plot 1000 of the actual and expected life claims by experience mod. Also illustrated in the plot is percent of life premium with SC overlap. Experience mod may be used in WC rating where rate is greater than 1 indicates bad WC claims experience and less than 1 indicates good WC experience. In cases 1010 where experience mod is greater than 1 there is an approximately 30% improvement above standard. Pricing may be increasing rate by up to 30% for WC cases with experience mod above 1.

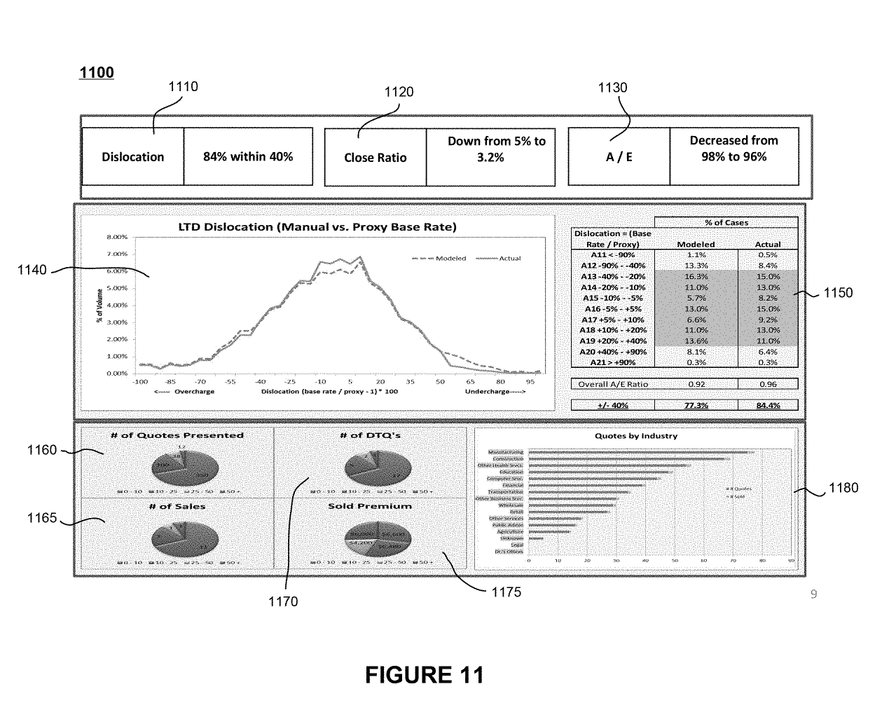

FIG. 11 illustrates a dashboard 1100 that may be provided within the transition layer 140 of FIGS. 1 and 2, for example. Dashboard 1100 includes a dislocation monitor 1110. As shown, the dislocation 1110 includes 84% within 40%. Dashboard 1100 monitors the close rate 1120. Close rate 1120 is the rate at which the policies that are quoted are activated. As shown the close rate 1120 is down from 5% to 3.2%. The actual vs. expected (A/E) 1130 is also monitored. As shown the A/E 1130 decreased from 98% to 96%.

Dashboard 1100 may also include a plot of the modeled LTD dislocation vs. actual in plot 1140. A tabular display of the data is also included in table 1150. A monitor of the number of quotes presented 1160, number of sales 1165, number of Direct-To-Quote (DTQs) 1170, and sold premium 1175 are shown. In addition, the quotes by industry 1180 may be shown.

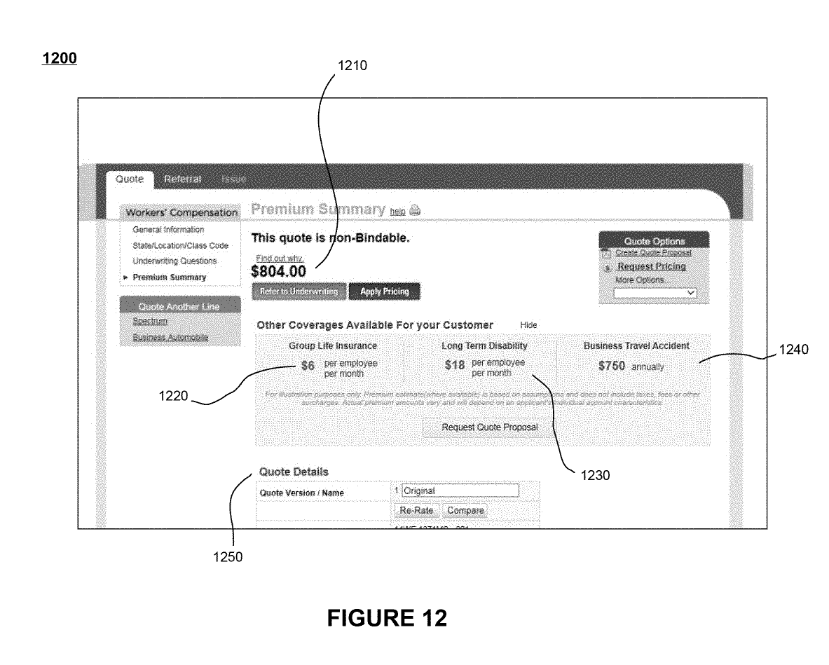

FIGS. 12-15 provide illustrations of presentable quotes from the QS 110 of FIG. 1. These quotes may be presented to external parties, to an agent, such as agent 150 of FIG. 1, or any other party.

By way of example, quote 1200 of FIG. 12 includes a quote for workers' compensation insurance 1210. WC quote 1210 may be binding or non-binding. Associated with the WC quote 1210 are other coverages available to the customer. These other coverages may include Group Life (GL) insurance quote 1220, LTD insurance quote 1230, and business travel accident insurance 1240. In addition, quote 1200 may include quote details 1250.

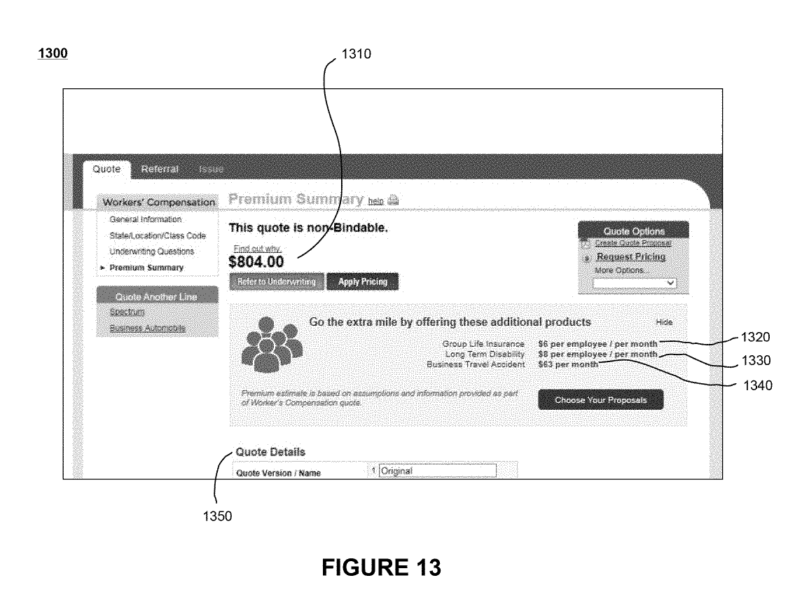

By way of further example, quote 1300 of FIG. 13 includes a quote for workers' compensation insurance 1310. WC quote 1310 may be binding or non-binding. Associated with the WC quote 1310 are other coverages available to the customer. These other coverages may include GL insurance quote 1320, LTD insurance quote 1330, and business travel accident insurance 1340. In addition, quote 1300 may include quote details 1350.

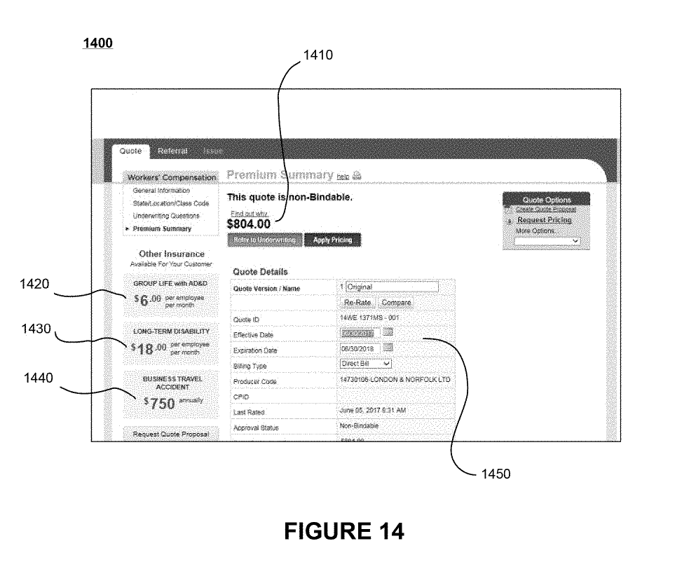

By way of further example, quote 1400 of FIG. 14 includes a quote for workers' compensation insurance 1410. WC quote 1410 may be binding or non-binding. Associated with the WC quote 1410 are other coverages available to the customer. These other coverages may include GL insurance quote 1420, LTD insurance quote 1430, and business travel accident insurance 1440. In addition, quote 1400 may include quote details 1450.

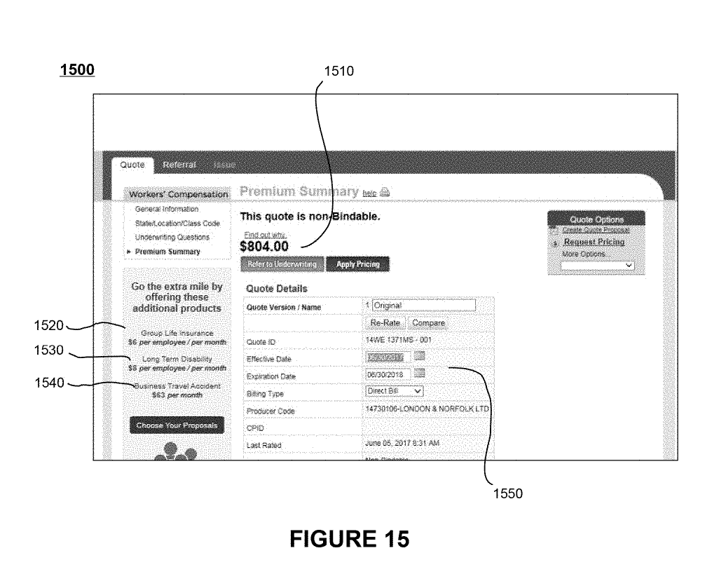

By way of further example, quote 1500 of FIG. 15 includes a quote for workers' compensation insurance 1510. WC quote 1510 may be binding or non-binding. Associated with the WC quote 1510 are other coverages available to the customer. These other coverages may include GL insurance quote 1520, LTD insurance quote 1530, and business travel accident insurance 1540. In addition, quote 1500 may include quote details 1550.

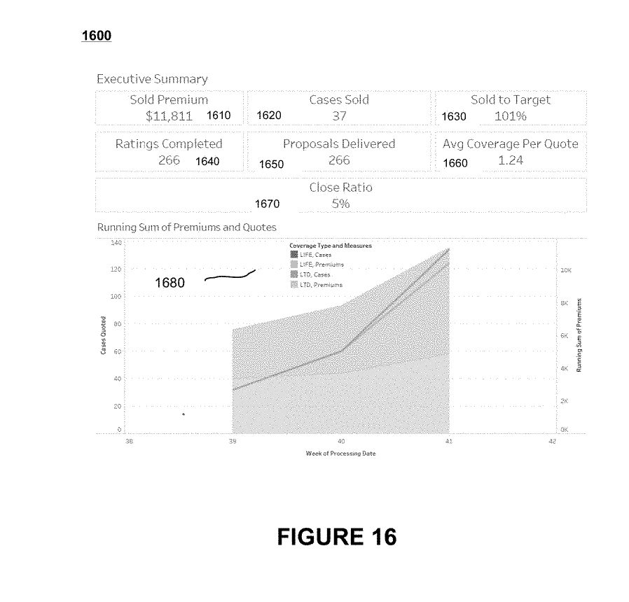

FIGS. 16-18 provide illustrations on the feedback within the system of FIGS. 1 and 2. Specifically, FIG. 16 illustrates feedback that is presented on dashboard 260 of FIG. 2, for example. FIG. 16 illustrates a depiction of a screen that provides an executive summary 1600. Executive summary 1600 provides a high-level view of the proxy system. Executive summary 1600 provides the sold premium 1610 and number of cases sold 1620 through the proxy system of FIGS. 1 and 2. Sold to target 1630 is also provided. Sold to target 1630 provides an indication of how the proxy system is working as compared to the values that would have been sold if all the information received after the fact was used in the quoting system. A number of 100% indicates that the same premiums on average would have been charged if all information had been received, while lower values indicate that the proxy system is under-representing the premium, and numbers above 100% indicates that the proxy system is charging more for coverage than would have been charged using the traditional system.

In addition, executive summary 1600 provides the number of ratings completed 1640, which indicates the number of times ratings were used with the proxy, and proposals delivered 1650, which indicates the number of times the broker/agent requests proposals through the proxy system. While in FIG. 16, ratings completed 1640 and proposals delivered 1650 are identical, this is likely not to be the case in practice as many ratings are likely to be computed, while only a subset of those ratings are going to result in proposals. Further, the number of closed proposals is indicated in the close ratio 1670. The average coverage per quote 1660 is provided that indicates the number of coverages provided per quote. The plot 1680 includes a running sum of premiums and quotes. As shown, a two-week window is indicated, although any time frame may be used.

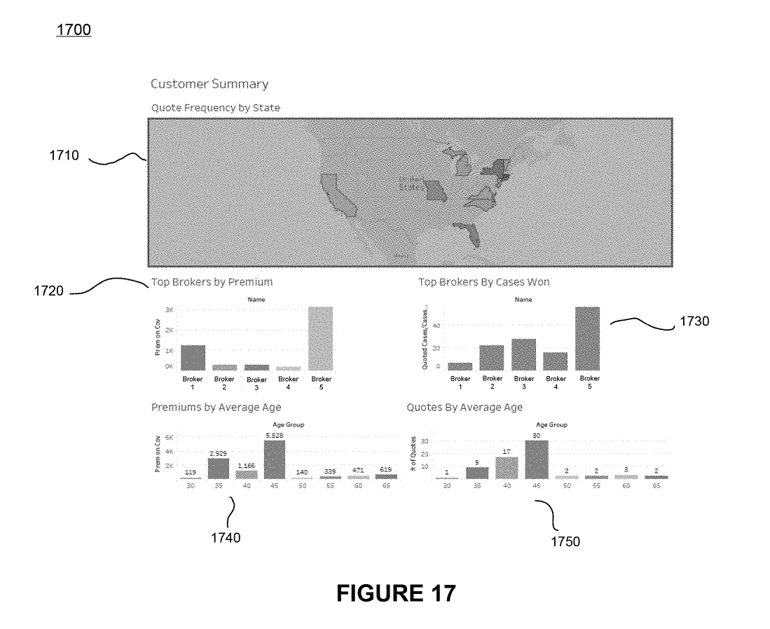

FIG. 17 illustrates additional feedback that is presented on dashboard 260 of FIG. 2. FIG. 17 illustrates a depiction of a screen that provides a customer summary 1700. Customer summary 1700 provides a deeper dive compared to executive summary 1600 with respect to the customer information. Customer summary 1700 indicates the quote frequency by state. In this case, this information is depicted in an image, although other depictions of the information may be provided. The top brokers by premium 1720, top brokers by cases won 1730, premiums by average age 1740, and quotes by average age 1750 are also provided. Each of the indications within the customer summary 1700 provides additional in depth detail into the broker information.

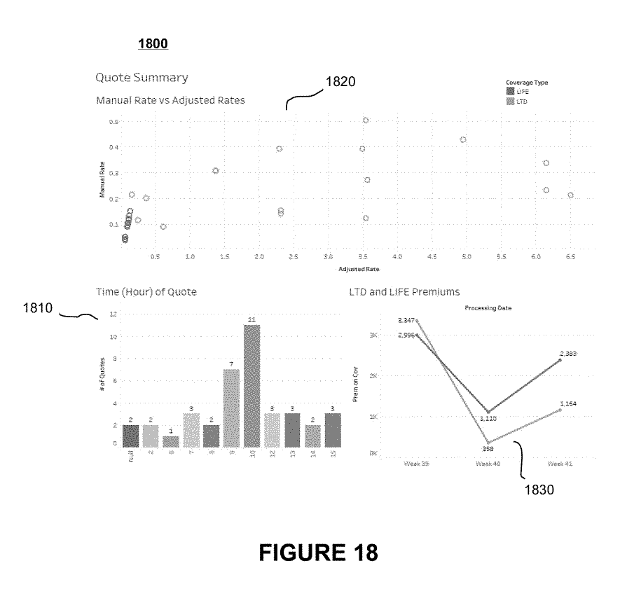

FIG. 18 illustrates additional feedback that is presented on dashboard 260 of FIG. 2. FIG. 18 illustrates a depiction of a screen that provides a quote summary 1800. Quote summary 1800 provides a more detailed analysis of quote information including the comparison to the traditional quoting system in order to understand trends. This summary provides the comparison quote by quote instead of by grouping quotes. For example, time of the quote 1810 is shown. LTD and premiums 1830 are plotted by week. A comparison 1820 of the proxied rate as compared to the traditional quoting system is plotted in order to bring forth systemic errors in the proxy quoting, for example.

Although features and elements are described above in particular combinations, one of ordinary skill in the art will appreciate that each feature or element can be used alone or in any combination with or without the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for providing and utilizing a proxy to provide group benefits products, the method comprising:
providing at least one variable for calculating applicability and cost of a group benefits product by proxy,
wherein the proxy is provided by information included in at least a workers compensation (WC) system.

2. The method of claim 1 wherein the at least one variable includes WC average salary.

3. The method of claim 1 wherein the at least one variable includes area.

4. The method of claim 1 wherein the at least one variable include industry.

5. The method of claim 1 wherein the at least one variable includes blue score.

6. The method of claim 1 wherein the at least one variable includes median household age.

7. The method of claim 1 wherein the group benefit product is long term disability insurance product.

8. The method of claim 1 wherein the group benefit product is a life insurance product.

9. A system for providing and utilizing a proxy to provide group benefits products, the method comprising:
a transition layer associated with a traditional group benefit system, the transition layer providing at least one variable for calculating applicability and cost of a group benefits product by proxy,
wherein the proxy is provided by information included in at least a workers compensation (WC) system.

10. The system of claim 9 wherein the at least one variable includes WC average salary.

11. The system of claim 9 wherein the at least one variable includes area.

12. The system of claim 9 wherein the at least one variable include industry.

13. The system of claim 9 wherein the at least one variable includes blue score.

14. The system of claim 9 wherein the at least one variable includes median household age.

15. The system of claim 9 wherein the group benefit product is long term disability insurance product.

16. The system of claim 9 wherein the group benefit product is a life insurance product.

17. The system of claim 9 wherein the transition layer fills in information for calculating the group benefit product using third party data.

18. The system of claim 9 wherein the calculated cost of the group benefits product by proxy is compared to a cost of the group benefits product calculated using the traditional group benefit system.

19. The system of claim 18 wherein variations in the comparison fed back to the transition layer to improve the use of the at least one variable for calculating applicability and cost of a group benefits product by proxy.

20. The system of claim 19 wherein the feedback is based on a sold to target ratio.
